(19) United States
(12) Patent Application Publication
(10) Pub. No.: US 2023/0209377 A1
(43) Pub. Date: Jun. 29, 2023

(54) APPARATUS, SYSTEM AND METHOD OF DETECTING CHANGES IN AN ENVIRONMENT OF A WIRELESS COMMUNICATION DEVICE

(71) Applicant: Intel Corporation, Santa Clara, CA (US)

(72) Inventors: Uri Parker, Shimshit (IL); Tal Ilani, Atzmon (IL); Assaf Gurevitz, Ramat Hasharon (IL)

(73) Assignee: Intel Corporation, Santa Clara, CA (US)

(21) Appl. No.: 17/561,364

(22) Filed: Dec. 23, 2021

(51) Int. Cl. H04W 24/08; H04L 25/02; H04B 17/345

(52) U.S. Cl. CPC H04W 24/08; H04L 25/0212; H04B 17/345

(57) ABSTRACT

For example, an apparatus may include a sensor configured to detect changes in an environment of a wireless communication device based on wireless communication signals communicated by the wireless communication device. For example, the sensor may include an input to receive signal information of a plurality of Receive (Rx) signals received by an Rx antenna of the wireless communication device based on a loopback of a plurality of wireless transmit (Tx) signals transmitted by a Tx antenna of the wireless communication device; and a processor configured to determine a detection result based on a change in the signal information between an Rx signal and at least one previous Rx signal of the plurality of Rx signals, the detection result to indicate a detected change in the environment of the wireless communication device.

### TECHNICAL FIELD

Aspects described herein generally relate to detecting changes in an environment of a wireless communication device.

### BACKGROUND

A proximity sensor may be implemented to detect proximity of a person to a computing device, for example, in order to wake up the computing device, e.g., when the person approaches the computing device, and/or to lock the computing device, e.g., when the person walks away from the computing device.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some exemplary aspects.

FIG. 2 is a schematic illustration of a detection scheme to detect changes in an environment of a wireless communication device, in accordance with some exemplary aspects.

FIG. 3 is a schematic illustration of a processing scheme to determine a detection result to indicate a detected change in an environment of a wireless communication device, in accordance with some demonstrative aspects.

FIG. 4 is a schematic illustration of fields of a packet, which may be implemented in accordance with some demonstrative aspects.

FIG. 5 is a schematic illustration of a graph depicting test results of a simulated detection scenario to detect proximity of a person to a wireless communication device, in accordance with some demonstrative aspects.

FIG. 6 is a schematic illustration of a first graph depicting Cumulative Distribution Functions (CDFs) of a plurality of first scenarios, and a second graph depicting CDFs of a plurality of second scenarios, in accordance with some demonstrative aspects.

FIG. 7 is a schematic flow-chart illustration of a method of detecting changes in an environment of a wireless communication device, in accordance with some demonstrative aspects.

FIG. 8 is a schematic illustration of a product of manufacture, in accordance with some exemplary aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2016 (IEEE 802.11-2020, IEEE Standard for Information Technology— Telecommunications and Information Exchange between Systems Local and Metropolitan Area Networks—Specific Requirements Part 11: Wireless LAN Medium Access Control (MAC) and Physical Layer (PHY) Specifications, December 2020)), and/or future versions and/or derivatives thereof, devices and/or networks operating in accordance with existing cellular specifications and/or protocols, e.g., 3rd Generation Partnership Project (3GPP), 3GPP Long Term Evolution (LTE), Fifth Generation (5G) Specifications, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), Time-Division Multiplexing (TDM), Time-Division Multiple Access (TDMA), Multi-User MIMO (MU-MIMO), General Packet Radio Service (GPRS), extended GPRS (EGPRS), Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group) and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub 8 GHz frequency band, e.g., a frequency band of 2.4 GHz, 5 GHz, and/or 6-7 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

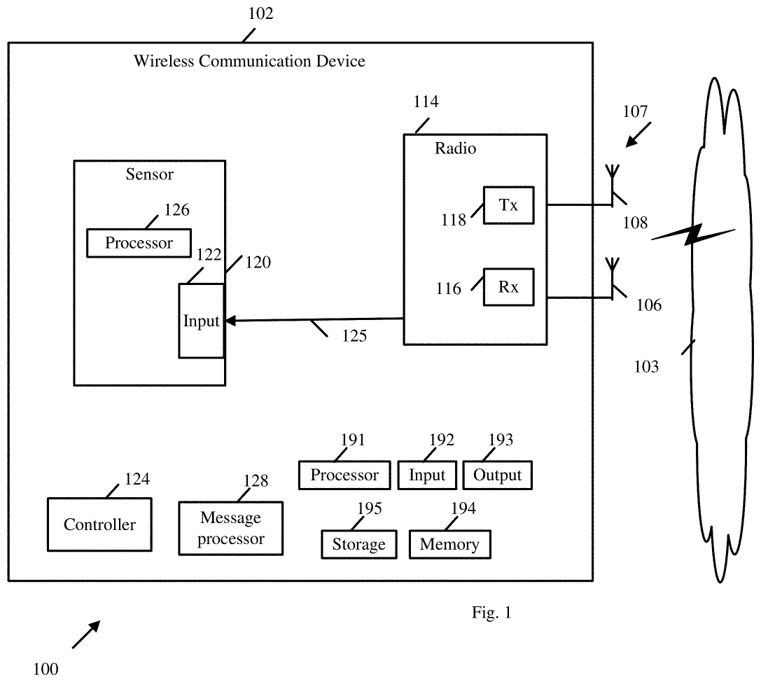

Reference is now made to FIG. 1, which schematically illustrates a block diagram of a system 100, in accordance with some exemplary aspects.

As shown in FIG. 1, in some demonstrative aspects, system 100 may include a wireless communication network including one or more wireless communication devices, e.g., a wireless communication device 102.

In some demonstrative aspects, wireless communication device 102 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a Bluetooth (BT) device, a Bluetooth Low Energy (BLE) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, operate as, and/or perform the functionality of one or more STAs. For example, device 102 may include at least one STA.

In some demonstrative aspects, device 102 may include, operate as, and/or perform the functionality of one or more WLAN STAs.

In some demonstrative aspects, device 102 may include, operate as, and/or perform the functionality of one or more Wi-Fi STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative aspects, device 102 may include a non-AP STA or an access point (AP) STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects, device 102 may include, operate as, and/or perform the functionality of a BT device.

In some demonstrative aspects, device 102 may include, operate as, and/or perform the functionality of a cellular communication device.

In some demonstrative aspects, device 102 may include, operate as, and/or perform the functionality of, any other devices and/or STA.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of device 102 may be enclosed in a common housing or packaging, and may be interconnected or operably associated using one or more wired or wireless links. In other aspects, components of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Light Emitting Diode (LED) display unit, an Organic LED (OLED) display unit, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a Solid State Drive (SSD), or other suitable removable or non-removable storage units. Memory unit 194 and/or storage unit 195, for example, may store data processed by device 102.

In some demonstrative aspects, wireless communication device 102 may be capable of communicating content, data, information, and/or signals via a wireless medium (WM) 103.

In some demonstrative aspects, wireless medium 103 may include, for example, a radio channel, a wireless communication channel, a BT channel, a BLE channel, a cellular channel, a Global Navigation Satellite System (GNSS) Channel, an RF channel, a WiFi channel, an IR channel, and the like.

In some demonstrative aspects, wireless communication medium 103 may include a sub-8 Ghz frequency band, for example, a 2.4 GHz frequency band, a 5 GHz frequency band, and/or a 6-7 GHz frequency band, and/or one or more other wireless communication frequency bands, for example, a millimeterWave (mmWave) frequency band, e.g., a 60 GHz frequency band, a Sub-1 GHz (S1G) band, and/or any other frequency band.

In some demonstrative aspects, device 102 may include one or more radios including circuitry and/or logic to perform wireless communication between device 102, and one or more other devices. For example, device 102 may include at least one radio 114.

In some demonstrative aspects, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116.

In some demonstrative aspects, radio 114 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118.

In some demonstrative aspects, radio 114, transmitter 118, and/or receiver 116 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, radio 114 may be configured to communicate over a sub 8 GHz band, e.g., a 2.4 GHz band, a 5 GHz band, and/or a 6-7 GHz band, and/or any other frequency band, e.g., a 60 GHz band, an S1G band, and/or any other band.

In some demonstrative aspects, radio 114 may include, or may be associated with, a plurality of antennas 107.

In some demonstrative aspects, transmitter 118 may include, or may be associated with, at least one Tx antenna 108, e.g., of the plurality of antennas 107.

In some demonstrative aspects, receiver 116 may include, or may be associated with, at least one Rx antenna 106, e.g., of the plurality of antennas 107. Antennas 107 may include any type of antennas suitable for transmitting and/or receiving wireless communication signals, blocks, frames, transmission streams, packets, messages and/or data. For example, antennas 107 may include any suitable configuration, structure, and/or arrangement of one or more antenna elements, components, units, assemblies, and/or arrays. In some aspects, antennas 107 may implement transmit and receive functionalities using separate transmit and receive antenna elements. In some aspects, antennas 107 may implement transmit and receive functionalities using common and/or integrated transmit/receive elements.

In some demonstrative aspects, device 102 may include a controller 124 configured to perform and/or to trigger, cause, instruct and/or control device 102 to perform, one or more communications, to generate and/or communicate one or more messages and/or transmissions, and/or to perform one or more functionalities, operations and/or procedures between device 102 and one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In some demonstrative aspects, at least part of the functionality of controller 124 may be implemented as part of one or more elements of radio 114.

In other aspects, the functionality of controller 124 may be implemented as part of any other element of device 102.

In some demonstrative aspects, device 102 may include a message processor 128 configured to generate, process and/or access one or more messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), e.g., a PHY Layer Convergence Procedure (PLCP) PDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, message processor 128 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processor 128, respectively. Additionally or alternatively, one or more functionalities of message processor 128 may be implemented by logic, which may be executed by a machine and/or one or more processors, e.g., as described below.

In some demonstrative aspects, at least part of the functionality of message processor 128 may be implemented as part of radio 114.

In some demonstrative aspects, at least part of the functionality of message processor 128 may be implemented as part of controller 124.

In other aspects, the functionality of message processor 128 may be implemented as part of any other element of device 102.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, device 102 may include, operate as, perform the role of, and/or perform one or more functionalities of, one or more STAs.

In some demonstrative aspects, device 102 may form, or may communicate as part of, a wireless local area network (WLAN).

In some demonstrative aspects, device 102 may form, or may communicate as part of, a WiFi network.

In other aspects, device 102 may form, and/or communicate as part of, any other additional or alternative network.

In some demonstrative aspects, device 102 may be configured to utilize a human proximity sensing mechanism based on wireless communication signals, e.g., Wi-Fi signals, e.g., as described below.

In some demonstrative aspects, a human proximity sensing mechanism may be configured to determine, for example, proximity of a human to wireless communication device 102, for example, based on the wireless communication signals communicated by the wireless communication device 102.

In some demonstrative aspects, the human proximity sensing mechanism may be implemented to provide a technical solution to improve a user experience of a user of the wireless communication device 102, for example, in one or more scenarios, e.g., as described below.

In one example, according to a first scenario (also referred to as “a wake on approach scenario”, or “an approach scenario”) the human proximity sensing mechanism may be implemented, for example, to indicate to a wireless communication device, e.g., a laptop, that the user is approaching the wireless communication device. According to this scenario, the wireless communication device may react to the indication, for example, to activate one or more elements of the wireless communication device, for example, a screen or any other element of the wireless communication device. For example, the wake on approach scenario may provide a technical solution to improve a responsiveness of the wireless communication device.

In one example, according to a second scenario (also referred to as “a walk-away lock scenario”, a “walk away scenario”, or “a lock scenario”) the human proximity sensing mechanism may be utilized, for example, to indicate to the wireless communication device, e.g., the laptop, that the user walks away from the wireless communication device. According to this scenario, the wireless communication device deactivate one or more functionalities of the wireless communication device, for example, the wireless communication device may dim the screen and/or lock the screen of wireless communication device, e.g., as soon as the user is detected to leave the wireless communication device. For example, the walk away lock scenario may provide a technical solution to improve privacy and/or security of the user, and/or to improve battery performance of the wireless communication device.

In some demonstrative aspects, for example, in some use cases, scenarios, and/or implementations, there may be one or more disadvantages, inefficiencies, and/or technical problems in implementing a passive human proximity sensing mechanism, which may be based on passive sensing of signals from other devices, e.g., as described below.

For example, a device, e.g., a laptop, implementing the passive human proximity sensing mechanism, may passively listen to beacon messages from one or more APs, e.g., Wi-Fi access points, for example, at a predetermined time instance and/or period, for example, 10 times per second. The device may monitor changes in a channel response, e.g., based on Channel State Information (CSI), of the received beacon signals, for example, to identify a movement near the laptop, which may correspond to the approach scenario or to the walk away scenario. For example, the passive human proximity sensing mechanism may be considered to be “passive” as no signal is actively transmitted from the device, and/or as the passive human proximity sensing mechanism may solely rely on received signals, e.g., from the one or more APs.

In one example, the passive human proximity sensing mechanism may be sensitive to a layout of the one or more APs. For example, the passive human proximity sensing mechanism may work well in a corporate environment, e.g., having a dense layout of APs on the ceiling. However, in other environments, e.g., without a dense layout or without APs, the passive human proximity sensing mechanism may not perform well, or may even fail. For example, in a non-dense AP environment, the performance of the passive human proximity sensing mechanism may provide degraded results, and/or in environments where no AP exists, the performance of the passive human proximity sensing mechanism may totally fail.

In another example, the reliance of the passive human proximity sensing mechanism on APs on the ceiling may introduce higher sensitivity, for example, to people walking on the floor of the environment, for example, even when these people are actually away from the device. For example, people walking near the APs may trigger false wake-ups of the device, which may degrade battery performance. For example, the false wake-ups may occur due to symmetry of a channel, which may make it difficult for the passive human proximity sensing mechanism to discern between movements near the AP and movements near the device.

In another example, the passive human proximity sensing mechanism may require performing training and/or pre-calibration operations. For example, the passive human proximity sensing mechanism may be based on wireless signals, which may be passively received at a predefined time period, e.g., beacons received at 100 msec intervals. For example, training and/or pre-calibration operations may be performed to accommodate human proximity sensing mechanism to the layout of the APs and/or an environment topology, which may significantly affect performance of the passive human proximity sensing mechanism. For example, the training and/or pre-calibration operations may be performed, for example, to determine two proximity states, e.g., a Proximity state H1 and a Non-Proximity state H0. For example, the two proximity states may correspond to a variance of the CSI.

In one example, the training may be performed on several APs, and an AP from the several APs may be selected. For example, an AP having a highest ratio between the two proximity states, e.g., Proximity state H1 and Non-Proximity state H0, may be selected. For example, the training of the proximity state H1, may require a notification from a host platform to a Wi-Fi Network Interface Card (NIC), for example, on the presence of a user close to the laptop, for example, by using a keyboard press. For example, the passive human proximity sensing mechanism may use the notification for the training and/or calibration of the proximity state H1. In addition, the passive human proximity sensing mechanism may use quiet periods, e.g., where no person may be around the laptop, for example, to train the Non-Proximity state H0.

In one example, the need to provide the notifications from the host platform to the Wi-Fi NIC for the training purposes, and/or the need to monitor several APs, may significantly complicate implementation of the passive human proximity sensing mechanism.

In some demonstrative aspects, for example, in some use cases, scenarios, and/or implementations, there may be one or more disadvantages, inefficiencies, and/or technical problems in implementing an active radar with millimeter waves, which may be used for gesture recognition, for example, for proximity sensing. For example, the active radar with millimeter waves may have a high complexity and/or a high cost. For example, the active radar with millimeter waves may require implementation of a dedicated silicon and/or a dedicated antenna.

In some demonstrative aspects, wireless communication device 102 may include a sensor 120, which may be configured to detect changes in an environment of the wireless communication device 102, for example, based on wireless communication signals communicated by the wireless communication device 102, e.g., as described below.

In some demonstrative aspects, sensor 120 may be configured to support a technical solution to detect the changes in the environment of the wireless communication device 102, for example, based on an active sensing approach, in which the wireless communication device 102 may actively transmit a wireless signal into the air and listen to the wireless signal, e.g., at the same time, for example, in a Tx-to-Rx loopback mode, e.g., as described below.

In some demonstrative aspects, sensor 120 may be configured to support a technical solution, which may utilize internal antennas of wireless communication device 102. For example, sensor 120 may be configured to utilize a first antenna of wireless communication device 102 to transmit a wireless signal, and a second antenna of wireless communication device 102 to receive the wireless signal, e.g., simultaneously. For example, sensor 120 may use Tx antenna 108 to transmit a known signal, e.g., a legitimate wireless communication signal, and Rx antenna 106 to receive the known signal e.g., as described below.

In some demonstrative aspects, sensor 120 may be configured to support a technical solution to track changes of the known signal, which may correspond to and/or indicate one or more detection states and/or scenarios, e.g., the walk-away lock scenario, the wake on approach scenario, and/or any other detection scenario and/or state, e.g., as described below.

In some demonstrative aspects, sensor 120 may be configured, e.g., according to the active sensing approach, to cause, trigger, instruct, and/or control wireless communication device to transmit a wireless signal at a predefined periodicity, e.g., several times per second, for example, at a very low transmit power, e.g., −20 dBm or any other transmit power, via the first antenna 108, and to simultaneously receive the wireless signal via the second antenna 106, for example, at an Rx-to-Tx loopback mode, e.g., as described below.

In some demonstrative aspects, sensor 120 may be configured to support a technical solution to track changes and/or variance of the received wireless signals, which may be localized and much stronger, for example, when a person approaches the wireless communication device 102, e.g., as described below.

In some demonstrative aspects, sensor 120 may be configured to support a technical solution to detect one or more changes in the environment of the wireless communication device 102, for example, by processing the received wireless signals, for example, based on one or more thresholds and/or hysteresis, e.g., as described below.

In some demonstrative aspects, sensor 120 may be configured to support a technical solution to detect proximity of the user to wireless communication device 102, for example, based on a set of thresholds and/or hysteresis, e.g., as described below.

In some demonstrative aspects, sensor 120 may be configured to support a technical solution to detect one or more changes in the environment of the wireless communication device 102, e.g., to detect the user proximity to wireless communication device 102, for example, with an improved performance level, e.g., as described below.

In some demonstrative aspects, sensor 120 may be configured to support a technical solution detect one or more changes in the environment of the wireless communication device 102, e.g., to detect the user proximity to wireless communication device 102, for example, at any environment, e.g., even without any sensitivity to a layout of APs. For example, sensor 120 may detect one or more changes in the environment of the wireless communication device 102, e.g., to detect the user proximity to wireless communication device 102, for example, regardless of whether or not an AP exists nearby.

In some demonstrative aspects, sensor 120 may be configured to support a technical solution, which may provide a reduced probability for a false wake-up situation. For example, wireless signals transmitted by the wireless communication device 102 may be localized around wireless communication device 102, e.g., due to the relatively low transmit power of the wireless signals. Accordingly, movements that are not close to the wireless communication device 102, e.g., at a radius greater than about 1.5 meters (m), may not be detected. Accordingly, such movements that are not close to the wireless communication device 102 may not cause false wakeups, e.g., as described below.

In some demonstrative aspects, sensor 120 may be configured to support a technical solution, which may not require a notification on a presence of a user, e.g., the notification from the host platform to the Wi-Fi NIC of the presence of the user, e.g., for training purposes. This may significantly reduce complexity of a system, for example, by avoiding the need to convey information from the host platform of wireless communication device 102 to a Wi-Fi NIC of wireless communication device 102.

In some demonstrative aspects, sensor 120 may be configured to support a technical solution, which may be much simpler, e.g., compared to the passive human proximity sensing, for example, by a factor of about 100, e.g., with respect to a firmware Microprocessor without Interlocked Pipeline Stages (MIPS) architecture.

In some demonstrative aspects, sensor 120 may be configured to detect changes in the environment of the wireless communication device 102, for example, based on operation of wireless communication device 102 as an active radar using sub-8 GHz wireless signals, e.g., Wi-Fi signals, as described below.

In some demonstrative aspects, sensor 120 may be configured to utilize wireless communication device 102 as an active radar, for example, based on transmission and reception of low-power sub-8 GHz wireless signals, for example, with a transmission power of no more than −20 dBM or any other transmission power, e.g., as described below.

In some demonstrative aspects, sensor 120 may be configured to utilize wireless communication device 102 as an active radar, for example, based on periodical transmission and reception of the low-power sub-8 GHz wireless signals, e.g., as described below.

In some demonstrative aspects, sensor 120 may be configured to utilize wireless communication device 102 as an active radar, for example, based on periodical transmission of low-power sub-8 GHz wireless signals configured as wireless communication packets of a wireless communication protocol, for example, Wi-Fi packets, e.g., as described below.

In one example, sensor 120 may be configured to utilize wireless communication device 102 as an active radar, for example, based on periodical transmission of low-power sub-8 GHz wireless signals configured as very short Wi-Fi packets, for example, Null-Data-Packets (NDPs), very short non-High Throughput (legacy) packets, Clear to Send (CTS) to self (CTS-to-self) packets, and/or any other packets.

In some demonstrative aspects, sensor 120 may be configured to utilize wireless communication device 102 as an active radar, for example, based on a Tx-to-Rx loopback of the sub-8 GHz wireless signals, e.g., as described below.

In some demonstrative aspects, sensor 120 may be configured to utilize wireless communication device 102 as a sub-8 GHz active radar, for example, for human proximity sensing, e.g., as described below.

In some demonstrative aspects, sensor 120 may be configured to utilize wireless communication device 102 as a sub-8 GHz active radar, for example, for gesture recognition, e.g., as described below.

In some demonstrative aspects, sensor 120 may be configured to utilize the Tx-to-Rx loopback of the sub-8 GHz wireless signals, for example, to detect a user approach situation and/or a user walk-away situation, e.g., as described below.

In some demonstrative aspects, sensor 120 may be configured to utilize wireless communication device 102 as a sub-8 GHz active radar, for example, for detection of any other additional or alternative changes in the environment of the wireless communication device 102.

In some demonstrative aspects, sensor 120 may include an input 122 to receive signal information 125 of a plurality of Rx signals received by Rx antenna 106 of the wireless communication device 102, for example, based on a loopback of a plurality of wireless Tx signals transmitted by Tx antenna 108 of the wireless communication device 102, e.g., as described below.

In some demonstrative aspects, sensor 120 may include a processor 126 configured to control, trigger, cause, and/or instruct one or more operations and/or functionalities of sensor 120 and/or wireless communication device 102, e.g., as described below.

In one example, one or more functionalities and/or operations of processor 126 may be implemented as part of controller 124.

In another example, one or more functionalities and/or operations of processor 126 may be implemented as part of processor 191.

In another example, one or more functionalities of processor 126 may be implemented by one or more other elements of wireless communication device 102, for example, by one or more dedicated and/or separate elements, which may be separate from controller 124 and/or processor 191.

In some demonstrative aspects, processor 126 may be configured to determine a detection result, for example, based on a change in the signal information 125 between an Rx signal and at least one previous Rx signal of the plurality of Rx signals, e.g., as described below.

In some demonstrative aspects, the at least one previous Rx signal may include an Rx signal immediately preceding the Rx signal, e.g., as described below.

In some demonstrative aspects, the at least one previous Rx signal may include any other Rx signal preceding the Rx signal.

In some demonstrative aspects, processor 126 may be configured to determine the detection result to indicate a detected change in the environment of the wireless communication device 102, e.g., e.g., as described below.

In some demonstrative aspects, processor 126 may be configured to determine the detection result to include a proximity detection result, for example, to indicate a detected human proximity to the wireless communication device 102, e.g., e.g., as described below.

In some demonstrative aspects, processor 126 may be configured to determine the detection result to include a user approach detection result, for example, to indicate a detected approach of a user to the wireless communication device 102, e.g., e.g., as described below.

In some demonstrative aspects, processor 126 may be configured to determine the detection result to include a user move-away detection result, for example, to indicate a user moving away from the wireless communication device 102, e.g., e.g., as described below.

In some demonstrative aspects, processor 126 may be configured to determine the detection result to include a gesture detection result, for example, to indicate a detected gesture of a user of the wireless communication device 102, e.g., e.g., as described below.

In some demonstrative aspects, processor 126 may be configured to determine the detection result to include any other additional and/or alternative information with respect to any other detected change in the environment of the wireless communication device 102.

In some demonstrative aspects, processor 126 may be configured to control, cause, trigger and/or instruct the wireless communication device 102, and/or transmitter 118 to periodically transmit the Tx signals, for example, based on a transmission periodicity, e.g., as described below.

In some demonstrative aspects, processor 126 may be configured to control, cause, trigger and/or instruct the wireless communication device 102, and/or transmitter 118 to transmit the Tx signals at a transmission periodicity of at least two signal transmissions per second, e.g., as described below.

In some demonstrative aspects, processor 126 may be configured to control, cause, trigger and/or instruct the wireless communication device 102, and/or transmitter 118 to transmit the Tx signals at a transmission periodicity of at least three signal transmissions per second, e.g., as described below.

In some demonstrative aspects, processor 126 may be configured to control, cause, trigger and/or instruct the wireless communication device 102, and/or transmitter 118 to transmit the Tx signals at a transmission periodicity of at least five signal transmissions per second, e.g., as described below.

In some demonstrative aspects, processor 126 may be configured to control, cause, trigger and/or instruct the wireless communication device 102, and/or transmitter 118 to transmit the Tx signals at a transmission periodicity of at least ten signal transmissions per second, e.g., as described below.

In other aspects, processor 126 may be configured to control, cause, trigger and/or instruct the wireless communication device 102, and/or transmitter 118 to transmit the Tx signals at any other transmission periodicity.

In some demonstrative aspects, processor 126 may be configured to control, cause, trigger and/or instruct the wireless communication device 102, and/or transmitter 118 to transmit the Tx signals at a predefined, e.g., relatively low, transmission power, e.g., as described below.

In some demonstrative aspects, processor 126 may be configured to control, cause, trigger and/or instruct the wireless communication device 102, and/or transmitter 118 to transmit the Tx signals at a transmission power of no more than 50 decibel-milliwatts (dBm), e.g., as described below.

In some demonstrative aspects, processor 126 may be configured to control, cause, trigger and/or instruct the wireless communication device 102, and/or transmitter 118 to transmit the Tx signals at a transmission power of no more than 30 dBm, e.g., as described below.

In some demonstrative aspects, processor 126 may be configured to control, cause, trigger and/or instruct the wireless communication device 102, and/or transmitter 118 to transmit the Tx signals at a transmission power of no more than 20 dBm, e.g., as described below.

In some demonstrative aspects, processor 126 may be configured to control, cause, trigger and/or instruct the wireless communication device 102, and/or transmitter 118 to transmit the Tx signals at a transmission power of no more than 10 dBm, e.g., as described below.

In other aspects, processor 126 may be configured to control, cause, trigger and/or instruct the wireless communication device 102, and/or transmitter 118 to transmit the Tx signals using any other transmission power, e.g., as described below.

In some demonstrative aspects, processor 126 may be configured to monitor a detection metric, and to determine the detection result based on the detection metric, e.g., as described below.

In some demonstrative aspects, the detection metric may be based, for example, on the change in the signal information 125, e.g., as described below.

In some demonstrative aspects, processor 126 may be configured to determine training information of a plurality of training symbols of the Rx signal, for example, based on signal information corresponding to the Rx signal, e.g., as described below.

In some demonstrative aspects, processor 126 may be configured to determine a value of the detection metric corresponding the Rx signal, for example, based on the training information of the plurality of training symbols of the Rx signal, e.g., as described below.

In some demonstrative aspects, processor 126 may be configured to determine the detection result, for example, based on the value of the detection metric corresponding the Rx signal, e.g., as described below.

In some demonstrative aspects, processor 126 may be configured to determine the value of the detection metric corresponding the Rx signal, for example, based on a correlation, e.g., in a time domain, between the training information of the plurality of training symbols of the Rx signal and reference training information, e.g., as described below.

In some demonstrative aspects, the training information of the plurality of training symbols of the Rx signal may include Long Training Field (LTF) information of a plurality of LTF symbols of the Rx signal, e.g., as described below.

In other aspects, the training information of the plurality of training symbols of the Rx signal may include any other additional or alternative information, e.g., of any other additional or alternative symbols of the Rx signal.

In some demonstrative aspects, processor 126 may be configured to determine a time-domain Channel Impulse Response (CIR) corresponding to the Rx signal, for example, based on the signal information corresponding to the Rx signal, e.g., as described below.

In some demonstrative aspects, processor 126 may be configured to determine the value of the detection metric corresponding the Rx signal, for example, based on the time-domain CIR corresponding to the Rx signal, e.g., as described below.

In some demonstrative aspects, processor 126 may be configured to determine the value of the detection metric corresponding the Rx signal, for example, based on a plurality of tap values of the time-domain CIR corresponding to the Rx signal, e.g., as described below.

In other aspects, processor 126 may be configured to determine the value of the detection metric corresponding the Rx signal based on any other additional or alternative values of the time-domain CIR corresponding to the Rx signal.

In some demonstrative aspects, processor 126 may be configured to determine the detection result, for example, based on a comparison between a value of the detection metric corresponding the Rx signal and a detection threshold, e.g., as described below.

In some demonstrative aspects, processor 126 may be configured to update the detection threshold, for example, based a reliability criterion corresponding to a reliability of the detection result, e.g., as described below.

In other aspects, processor 126 may be configured to update the detection threshold based on any other additional or alternative attribute and/or criteria.

In some demonstrative aspects, processor 126 may be configured to selectively use signal information corresponding to a particular Rx signal in determining the detection result, e.g., as described below.

In some demonstrative aspects, processor 126 may be configured to select whether or not signal information corresponding to a particular Rx signal is to be used for determining the detection result, for example, based on a noise estimation corresponding to the signal information corresponding to the particular Rx signal, e.g., as described below.

In other aspects, processor 126 may be configured to select whether or not signal information corresponding to a particular Rx signal based on any other additional or alternative information and/or criteria.

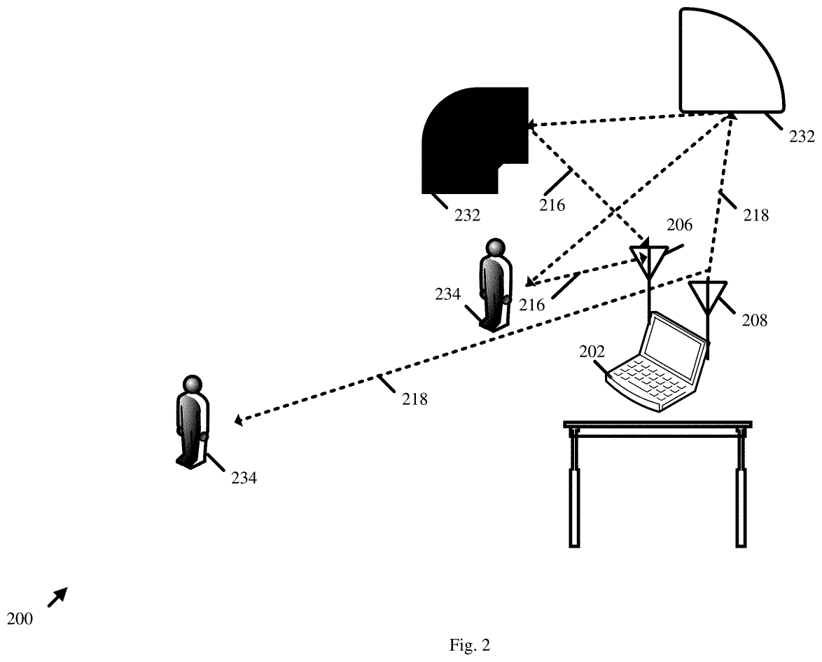

Reference is made to FIG. 2, which schematically illustrates a detection scheme 200 to detect changes in an environment of a wireless communication device 202, in accordance with some demonstrative aspects. For example, wireless communication device 202 may include one or more elements of device 102 (FIG. 1), and/or may perform one or more operations and/or functionalities of device 102 (FIG. 1).

In one example, as shown in FIG. 2, wireless communication device 202 may include a laptop.

In another example, wireless communication device 202 may include any other wireless communication device.

In some demonstrative aspects, as shown in FIG. 2, detection scheme 200 may be configured to detect changes in the environment of wireless communication device 202, for example, based on a Tx=to-Rx loopback of wireless signals between a Tx antenna 208 and an Rx antenna 206 of the wireless communication device 202.

In some demonstrative aspects, as shown in FIG. 2, wireless communication device 202 may transmit Tx radio signals 218 from Tx antenna 208, and may receive Rx radio signals 216 via Rx antenna 206, e.g., based on the Tx radio signals 218. For example, the reception of an Rx radio signal 216 may be substantially simultaneous with the transmission of a respective Tx radio signal 218.

In some demonstrative aspects, as shown in FIG. 2, Rx radio signals 216 may be based on a reflections of the Tx radio signals 218 from one or more close-in objects 232 and/or from one or more persons 234.

In some demonstrative aspects, the wireless communication device 202 may include a sensor, e.g., sensor 120 (FIG. 1), which may be configured to monitor the Rx radio signals 216 over time, for example, in order to detect changes in the Rx signal 216s, which may indicate changes in the environment of the wireless communication device 202.

In some demonstrative aspects, the sensor, e.g., sensor 120 (FIG. 1), may be configured to analyze a variance of the Rx signals 216, for example, to detect changes, e.g., motion, in the environment of wireless communication device 202.

In some demonstrative aspects, the sensor, e.g., sensor 120 (FIG. 1), may be configured to analyze the variance of the Rx signals 216, for example, to detect changes in the Rx signals 216, which may be indicative of one or more predefined events, for example, a proximity event, a non-proximity event, a gesture event, and/or any other events.

In some demonstrative aspects, the sensor, e.g., sensor 120 (FIG. 1), may be configured to control, cause, trigger and/or instruct the wireless communication device 202 to wake up, for example, based on detection of changes in the Rx signals 216, which may be indicative of a predefined proximity event, e.g., when a person arrives at a distance range of about 0.5-2 m from the wireless communication device 202.

In some demonstrative aspects, the sensor, e.g., sensor 120 (FIG. 1), may be configured to control, cause, trigger and/or instruct the wireless communication device 202 to switch to a locked mode, e.g., by locking a screen and/or any other components of wireless communication device 202, for example, based on detection of changes in the Rx signals 216, which may be indicative of a predefined non-proximity event. For example, the predefined non-proximity event may include an event when the user leaves the wireless communication device 202, e.g., when the user is located at a distance greater than two meters, or any other distance, from the wireless communication device 202.

In some demonstrative aspects, Tx radio signals 218 may be transmitted and received, e.g., substantially simultaneously, by wireless communication device 202, for example, in a loopback through the air.

In some demonstrative aspects, Tx radio signals 218 may be transmitted several times per second, e.g., 3-5 times per second and/or at any other periodicity.

In some demonstrative aspects, Tx radio signals 218 may be transmitted by wireless communication device 202 using a relatively low transmit power, e.g., a transmit power of −20 dBm and/or any other transmit power.

In some demonstrative aspects, the relatively low transmit power for transmission of Tx radio signals 218 may provide a technical solution to ensure locality of the Tx signals 218, that may be used by the sensor in the detection of the changes in the environment of wireless communication device 202. For example, due to the relatively low transmit power for transmission of Tx radio signals 218, signals which travel a relatively long distance, e.g., more than about 2 m, may be received by a receiver of wireless communication device 202 with a very low energy, which may not be detected and/or distinguished from “background noise”.

In some demonstrative aspects, an Automatic Gain Control (AGC) setting may be configured to set Rx radio signals 216 at an appropriate, e.g., optimum, digital level, for example, with a suitable Peak-to-Average Power Ratio (PAPR) back-off, and/or a suitable Error vector magnitude (EVM).

In one example, the AGC setting may be affected by a leakage between the Tx antenna 208 and the Rx antenna 206. For example, the AGC setting may be calibrated, for example, per platform.

In some demonstrative aspects, the sensor 120 (FIG. 1) and/or the wireless communication device 202 may be configured to mitigate one or more interferences, for example, from adjacent and/or nearby wireless communication devices, e.g., laptops.

In some demonstrative aspects, the sensor 120 (FIG. 1) and/or the wireless communication device 202 may mitigate the one or more interferences, for example, by performing cross correlation with an expected signal, which may result with a processing gain, which may lower an interfering noise.

In some demonstrative aspects, the sensor 120 (FIG. 1) and/or the wireless communication device 202 may mitigate the one or more interferences, for example, by performing EVM measurements per packet, for example, to filter out packets having bad Signal to Interference Noise Ratio (SINR).

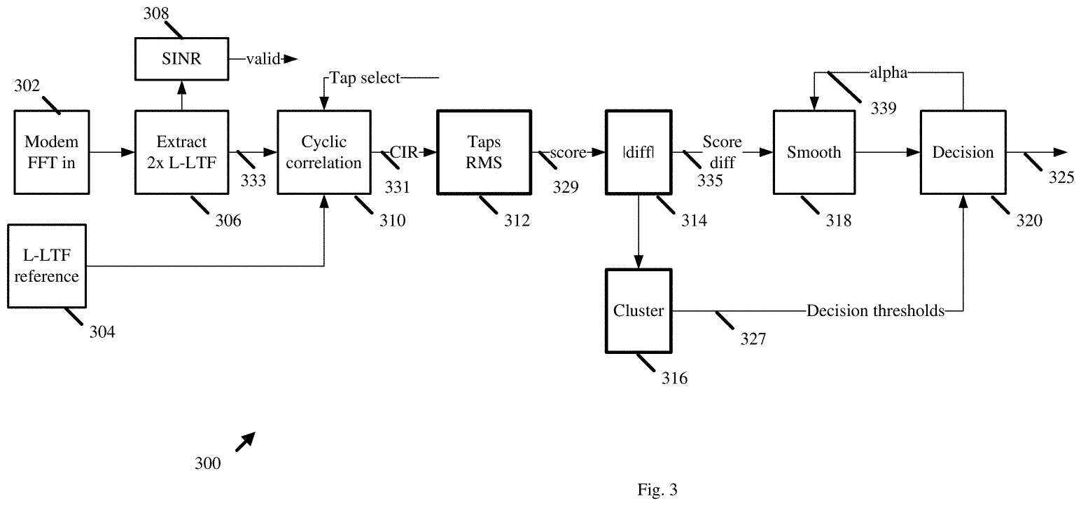

Reference is made to FIG. 3, which schematically illustrates a processing scheme 300 to determine a detection result 325 to indicate a detected change in an environment of a wireless communication device, in accordance with some demonstrative aspects.

In one example, processor 126 (FIG. 1) may be configured to implement one or more functionalities and/or operations of processing scheme 300, for example, to determine the detection result to indicate the detected change in the environment of wireless communication device 102 (FIG. 1).

In some demonstrative aspects, as indicated at block 306, processing scheme 300 may include extracting LTF information 333 of a plurality of LTF symbols of an Rx signal, which may be provided by an FFT input 302 of a receiver, e.g., receiver 116 (FIG. 1).

In one example, LTF information 333 may include Time domain samples of a first portion, e.g., first 16 microseconds (us), of a packet, which may arrive at the FFT input 302 of the receiver. For example, LTF information 333 may include two equal LTF symbols of the packet. In other aspects, any other number of LTF symbols and/or any other symbols of the packet may be used.

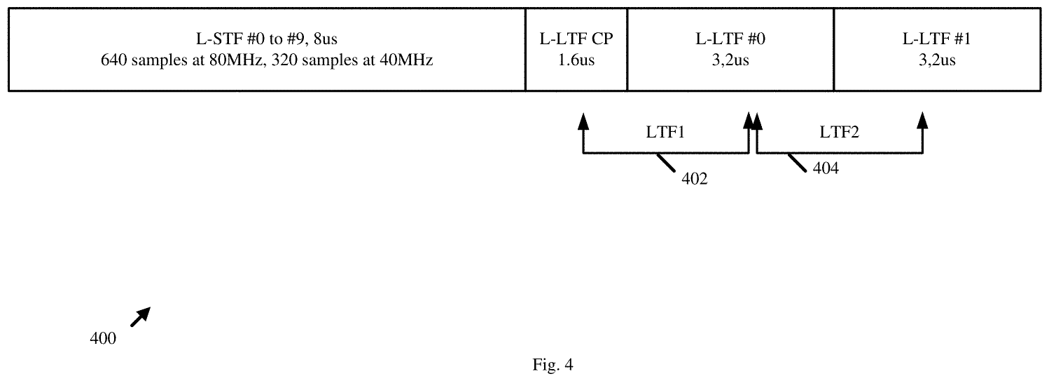

Reference is made to FIG. 4, which schematically illustrates fields of a packet 400, which may be implemented in accordance with some demonstrative aspects.

In one example, processor 126 (FIG. 1) may extract Time-domain samples of a portion of packet 400, e.g., including the first 16 us of packet 400, which may include two equal LTF symbols of the packet 400. For example, processor 126 (FIG. 1) may extract a first LTF symbol 402 of the packet 400, and a second LTF symbol 404 of the packet 400.

Referring back to FIG. 3, in some demonstrative aspects, as indicated at block 308, processing scheme 300 may include estimating a noise parameter e.g., a Signal to Interference Ratio (SINR) or any other parameter, corresponding to LTF information 333, for example, to determine whether or not the Rx signal is to be used for determining the detection result 325.

In one example, processor 126 (FIG. 1) may use two equal LTF symbols, denoted “LTF1” and “LTF2”, of the packet, e.g., LTF symbols 402 and 404 (FIG. 4), to calculate an SINR of the Rx signal, for example, by subtracting the two equal LTF, e.g., as follows:

$$SIN R = \frac{{\sum }_{i = 0}^{Nltf - 1} {\vert LTF {1}_{i} \vert}^{2}}{{\sum }_{i = 0}^{Nltf - 1} {\vert LTF {1}_{i} - LTF {2}_{i} \vert}^{2}} \qquad ( 1 )$$

In some demonstrative aspects, packets having a bad SINR, for example, as may be determined according to Equation 1, may be filtered out, for example, to mitigate interference, e.g., from nearby and/or adjacent wireless communication devices.

In some demonstrative aspects, as indicated at block 310, processing scheme 300 may include performing a correlation, e.g., a cyclic cross-correlation in the time domain, or any other correlation, between the LTF information 333 of the plurality of LTF symbols and reference LTF information 304, e.g., of a predetermined reference signal.

In some demonstrative aspects, as indicated by arrow 331, the cyclic cross-correlation between the LTF information 333 and reference LTF information 304 may be performed to estimate a time-domain CIR 331, for example, representing a plurality of tap values of the time-domain CIR 331, e.g., time-domain channel taps.

In some demonstrative aspects, processor 126 (FIG. 1) may apply the cyclic cross-correlation in the time domain, between extracted LTF symbols LTF1 and LTF2 and reference LTF information 304, for example, to determine CIR 331, e.g., as follows:

$${CIR}_{m} = {\sum }_{k = 0}^{Nltf - 1} {LF}_{m - k mod Nltf} \cdot {REF}_{k} , m is the tap index \qquad ( 2 )$$

In some demonstrative aspects, low power channel taps may be omitted, for example, to ensure locality of relevant reflections.

In some demonstrative aspects, processor 126 (FIG. 1) may determine one or more pre-taps and/or post taps, for example, in order to locate and select peak, which may move left or right by one tap.

In some demonstrative aspects, as indicated at block 312, processing scheme 300 may include determining a score 329, e.g., a Root Mean Square (RMS) score, denoted score, from one or more selected taps of the plurality of tap values of the time-domain CIR 331.

In one example, processor 126 (FIG. 1) may be configured to determine the score 329, for example, based on the taps of the time-domain CIR 331, e.g., as follows:

$${score}_{n} = \sqrt{\frac{{\sum }_{m = peak - pre \_ taps}^{peak + post \_ taps} {\vert {CIR}_{m} \vert}^{2}}{post\_taps + pre\_taps + 1}} \qquad ( 3 )$$

In other aspects, the score 329 may be determined according to any other RMS calculation, and/or any other calculation.

In some demonstrative aspects, as indicated at block 314, processing scheme 300 may include determining a value 335 of a detection metric, denoted METRIC, for example, based on the score 329.

In some demonstrative aspects, the value 335 of the detection metric may be determined, for example, based on a difference between the score 329 of the Rx signal and a score, e.g., according to Equation 3, of at least one previous Rx signal.

In some demonstrative aspects, the value 335 of the detection metric may be configured, for example, to distinguish between one or more predefined detection events, for example, a user proximity event, a non-proximity event, a gesture event and/o any other events.

In some demonstrative aspects, processor 126 (FIG. 1) may determine the value 335 of the detection metric METRIC, for example, based on an absolute difference between the score 329 of the Rx signal and the score of the previous Rx signal, e.g., as follows:

METRICₙ=gain·|scoreₙ−scoreₙ₋| (4)

In other aspects, the value 335 of the detection metric may be defined based on any other calculation and/or parameter.

In some demonstrative aspects, as indicated at block 320, processing scheme 300 may include determining the detection result 325 based on a comparison between the value 335 of the detection metric METRIC and at least one detection threshold 327.

In some demonstrative aspects, as indicated at block 318, the value 335 of the detection metric METRIC may be smoothed, and may be used as an input to a Hysteresis logic. For example, the Hysteresis may be applied to improve stability of the decision loop at block 320.

In some demonstrative aspects, as indicated at block 316, processing scheme 300 may include clustering values 335 of the detection metric METRIC, for example, per a plurality of predefined detection states, e.g., a proximity state vs a non-proximity state, for example, to determine and/or update the detection threshold 327.

In some demonstrative aspects, as indicated by arrow 339, processing scheme 300 may include alpha filtering, which may be applied, for example, on low and/or high metric values, for example, to average metric levels and/or to set appropriate thresholds.

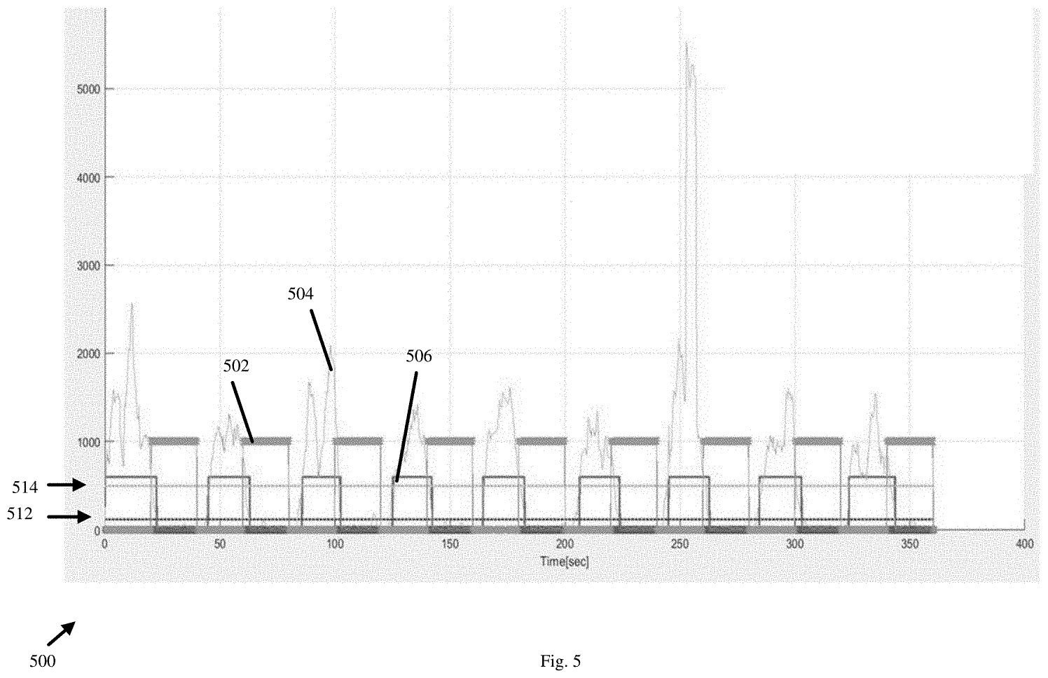

Reference is made to FIG. 5, which schematically illustrates a graph 500 depicting test results of a simulated detection scenario to detect proximity of a person to a wireless communication device, in accordance with some demonstrative aspects.

For example, graph 500 may represent test results of a simulated detection scenario including a person arriving and leaving an area of the wireless communication device, e.g., a laptop, for example, several times, for example, for a period of about 30 seconds. For example, the simulated scenario may correspond to day-to-day regular working conditions in an open-space cubic environment, for example, where other people may walk and move near the area of the wireless communication device

In one example, the test results may be determined by a processor, e.g., processor 126 (FIG. 1), for example, according to processing scheme 300 (FIG. 3).

In some demonstrative aspects, as shown in FIG. 5, a line 502 depicts true distance of the person from the wireless communication device.

In some demonstrative aspects, as shown in FIG. 5, a line 504 depicts values of a detection metric, e.g., values 335 of the detection metric METRIC.

In some demonstrative aspects, as shown in FIG. 5, a line 506 depicts detection results, e.g., decision results 325 (FIG. 3) generated by processor 126 (FIG. 1), for example, according to processing scheme 300 (FIG. 3), for example, to determine whether or not the person is near the laptop.

In some demonstrative aspects, as shown in FIG. 5, the detection results 506 may be based on a comparison between values of the line 504 and a low detection threshold 512, e.g., corresponding to a no-proximity detection state, and a high detection threshold 514, e.g., corresponding to a proximity detection state.

In some demonstrative aspects, as shown in FIG. 5, an accuracy of the detection results, e.g., according to line 506, may be very high, e.g., an accuracy of about 99%, for example, compared to the true results, e.g., according to line 502.

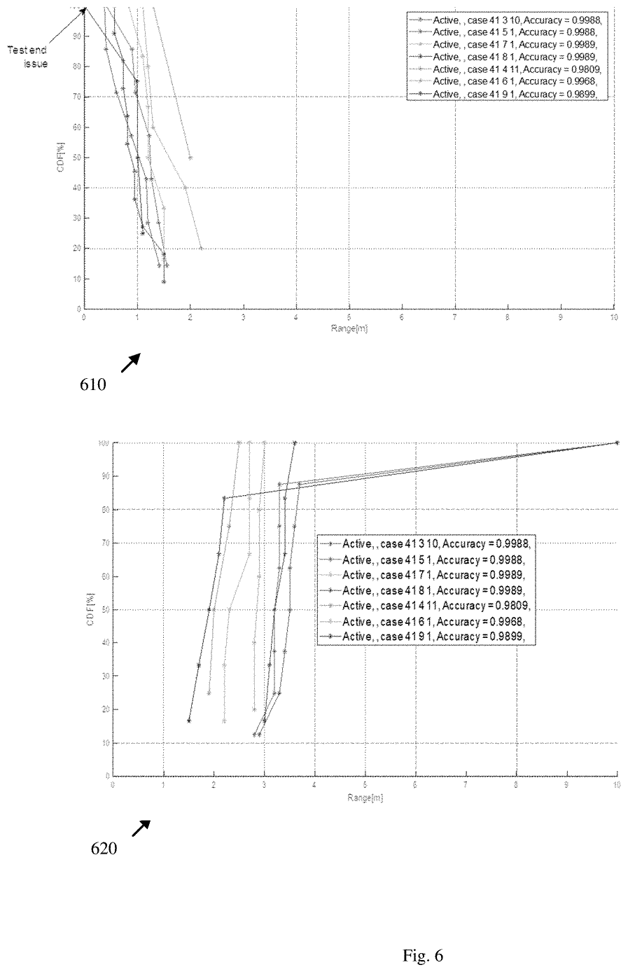

Reference is made to FIG. 6, which schematically illustrates a first graph 610 depicting Cumulative Distribution Functions (CDFs) corresponding to a plurality of first scenarios, and a second graph 620 depicting CDFs corresponding to a plurality of second scenarios, in accordance with some demonstrative aspects.

In one example, the plurality of first scenarios may include a plurality of approach scenarios, in which a user approaches a wireless communication device, and the plurality of second scenarios may include a plurality of walk away scenarios, where the user walks away from the wireless communication device.

For example, graph 610 shows CDFs of the plurality of approach scenarios, for example, as may be detected based on processing scheme 300 (FIG. 3).

In some demonstrative aspects, as shown in FIG. 6, all approach events in the approach scenarios may be discovered, for example, within a Key Performance Indicator (KPI) requirements window between 0.5 to 2 m.

For example, graph 620 shows CDFs of the plurality of walk away scenarios, for example, as may be detected based on processing scheme 300 (FIG. 3).

In some demonstrative aspects, as shown in FIG. 6, all walk-away events in the walkaway scenarios may be discovered, for example, according to the KPI requirements.

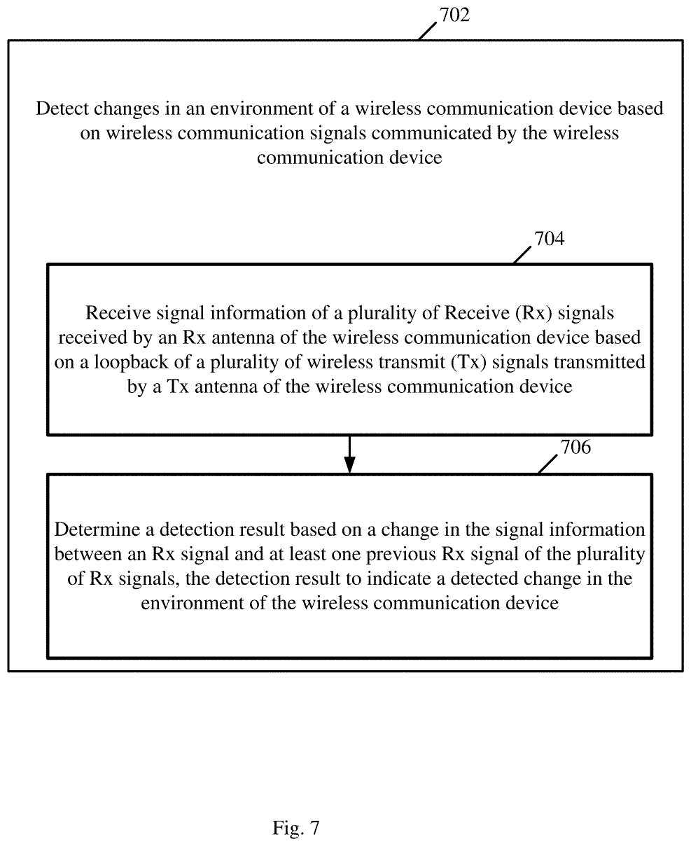

Reference is made to FIG. 7, which schematically illustrates a method of detecting changes in an environment of a wireless communication device, in accordance with some exemplary aspects For example, one or more operations of the method of FIG. 7 may be performed by one or more elements of a system, e.g., system 100 (FIG. 1), for example, a wireless device, e.g., device 102 (FIG. 1), a sensor, e.g., sensor 120 (FIG. 1), a processor, e.g., processor 126 (FIG. 1), a controller, e.g., controller 124 (FIG. 1), a radio, e.g., radio 114 (FIG. 1), a transmitter, e.g., transmitter 118 (FIG. 118), and/or a receiver, e.g., receiver 116 (FIG. 1).

As indicated at block 702, the method may include detecting changes in an environment of a wireless communication device based on wireless communication signals communicated by the wireless communication device. For example, sensor 120 (FIG. 1) may be configured to detect changes in the environment of the wireless communication device 102 (FIG. 1), for example, based on the wireless communication signals communicated by the wireless communication device 102 (FIG. 1), e.g., as described above.

As indicated at block 704, detecting the changes in the environment of the wireless communication device may include processing signal information of a plurality of Rx signals received by an Rx antenna of the wireless communication device based on a loopback of a plurality of wireless Tx signals transmitted by a Tx antenna of the wireless communication device. For example, processor 126 (FIG. 1) may receive, e.g., via input 122 (FIG. 1), signal information 125 (FIG. 1) of the plurality of Rx signals received by Rx antenna 106 (FIG. 1) based on the loopback of the plurality of wireless Tx signals transmitted by the Tx antenna 108 (FIG. 1), e.g., as described above.

As indicated at block 706, detecting the changes in the environment of the wireless communication device may include determining a detection result based on a change in the signal information between an Rx signal and at least one previous Rx signal of the plurality of Rx signals, the detection result to indicate a detected change in the environment of the wireless communication device. For example, processor 126 (FIG. 1) may determine the detection result based on the change in the signal information 125 (FIG. 1) between the Rx signal and the at least one previous Rx signal of the plurality of Rx signals, e.g., as described above.

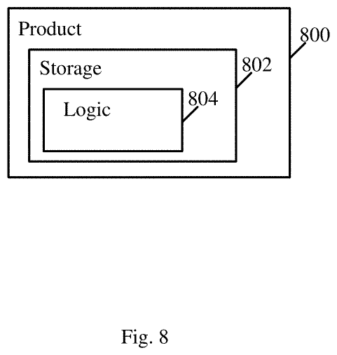

Reference is made to FIG. 8, which schematically illustrates a product of manufacture 800, in accordance with some exemplary aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), sensor 120 (FIG. 1), processor 126 (FIG. 1), controller 124 (FIG. 1), radio 114 (FIG. 1), receiver 116 (FIG. 1), transmitter 118 (FIG. 1), and/or message processor 128 (FIG. 1), to cause device 102 (FIG. 1), sensor 120 (FIG. 1), processor 126 (FIG. 1), controller 124 (FIG. 1), radio 114 (FIG. 1), receiver 116 (FIG. 1), transmitter 118 (FIG. 1), and/or message processor 128 (FIG. 1) to perform, trigger and/or implement one or more operations and/or functionalities, and/or to perform, trigger and/or implement one or more operations and/or functionalities described with reference to the FIGS. 1-7, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 800 and/or machine-readable storage media 802 may include one or more types of computer-readable storage media capable of storing data, including volatile memory, non-volatile memory, removable or non-removable memory, erasable or non-erasable memory, writeable or re-writeable memory, and the like. For example, machine-readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a Solid State Drive (SSD), and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language.

### EXAMPLES

The following examples pertain to further aspects.

Example 1 includes an apparatus comprising a sensor configured to detect changes in an environment of a wireless communication device based on wireless communication signals communicated by the wireless communication device, the sensor comprising an input to receive signal information of a plurality of Receive (Rx) signals received by an Rx antenna of the wireless communication device based on a loopback of a plurality of wireless transmit (Tx) signals transmitted by a Tx antenna of the wireless communication device; and a processor configured to determine a detection result based on a change in the signal information between an Rx signal and at least one previous Rx signal of the plurality of Rx signals, the detection result to indicate a detected change in the environment of the wireless communication device.

Example 2 includes the subject matter of Example 1, and optionally, wherein the processor is configured to monitor a detection metric, the detection metric based on the change in the signal information, and to determine the detection result based on the detection metric.

Example 3 includes the subject matter of Example 2, and optionally, wherein the processor is configured to determine training information of a plurality of training symbols of the Rx signal based on signal information corresponding to the Rx signal, to determine a value of the detection metric corresponding the Rx signal based on the training information of the plurality of training symbols of the Rx signal, and to determine the detection result based on the value of the detection metric corresponding the Rx signal.

Example 4 includes the subject matter of Example 3, and optionally, wherein the processor is configured to determine the value of the detection metric corresponding the Rx signal based on a correlation, in a time domain, between the training information of the plurality of training symbols of the Rx signal and reference training information.

Example 5 includes the subject matter of Example 3 or 4, and optionally, wherein the training information of the plurality of training symbols of the Rx signal comprises Long Training Field (LTF) information of a plurality of LTF symbols of the Rx signal.

Example 6 includes the subject matter of any one of Examples 2-5, and optionally, wherein the processor is configured to determine a time-domain Channel Impulse Response (CIR) corresponding to the Rx signal based on signal information corresponding to the Rx signal, and to determine a value of the detection metric corresponding the Rx signal based on the time-domain CIR corresponding to the Rx signal.

Example 7 includes the subject matter of Example 6, and optionally, wherein the processor is configured to determine the value of the detection metric corresponding the Rx signal based on a plurality of tap values of the time-domain CIR corresponding to the Rx signal.

Example 8 includes the subject matter of any one of Examples 2-7, and optionally, wherein the processor is configured to determine the detection result based on a comparison between a value of the detection metric corresponding the Rx signal and a detection threshold.

Example 9 includes the subject matter of Example 8, and optionally, wherein the processor is configured to update the detection threshold based a reliability criterion corresponding to a reliability of the detection result.

Example 10 includes the subject matter of any one of Examples 1-9, and optionally, wherein the processor is configured to select whether or not signal information corresponding to a particular Rx signal is to be used for determining the detection result based on a noise estimation corresponding to the signal information corresponding to the particular Rx signal.

Example 11 includes the subject matter of any one of Examples 1-10, and optionally, wherein the at least one previous Rx signal comprises an Rx signal immediately preceding the Rx signal.

Example 12 includes the subject matter of any one of Examples 1-11, and optionally, wherein the apparatus is configured to cause the wireless communication device to transmit the Tx signals at a transmission power of no more than 50 decibel-milliwatts (dBm).

Example 13 includes the subject matter of any one of Examples 1-12, and optionally, wherein the apparatus is configured to cause the wireless communication device to transmit the Tx signals at a transmission power of no more than 30 decibel-milliwatts (dBm).

Example 14 includes the subject matter of any one of Examples 1-13, and optionally, wherein the apparatus is configured to cause the wireless communication device to transmit the Tx signals at a transmission power of no more than 20 decibel-milliwatts (dBm).

Example 15 includes the subject matter of any one of Examples 1-14, and optionally, wherein the apparatus is configured to cause the wireless communication device to transmit the Tx signals at a transmission periodicity of at least two signal transmissions per second.

Example 16 includes any one of Examples 1-15, and optionally, wherein the apparatus is configured to cause the wireless communication device to transmit the Tx signals at a transmission periodicity of at least three signal transmissions per second.

Example 17 includes the subject matter of any one of Examples 1-16, and optionally, wherein the detection result comprises a proximity detection result to indicate a detected human proximity to the wireless communication device.

Example 18 includes the subject matter of any one of Examples 1-17, and optionally, wherein the detection result comprises user approach detection result to indicate a detected approach of a user to the wireless communication device.

Example 19 includes the subject matter of any one of Examples 1-18, and optionally, wherein the detection result comprises user move-away detection result to indicate a user moving away from the wireless communication device.

Example 20 includes the subject matter of any one of Examples 1-19, and optionally, wherein the detection result comprises a gesture detection result to indicate a detected gesture of a user of the wireless communication device.

Example 21 includes the subject matter of any one of Examples 1-20, and optionally, comprising a transmitter to transmit the plurality of wireless Tx signals, a receiver to receive the plurality of Rx signals, the Tx antenna, and the Rx antenna.

Example 22 comprises a wireless communication device comprising the apparatus of any one of Examples 1-21.

Example 23 comprises an apparatus comprising means for executing any of the described operations of Examples 1-21.

Example 24 comprises a product comprising one or more tangible computer-readable non-transitory storage media comprising computer-executable instructions operable to, when executed by at least one processor, enable the at least one processor to cause a device to perform any of the described operations of Examples 1-21.

Example 25 comprises an apparatus comprising: a memory interface; and processing circuitry configured to: perform any of the described operations of Examples 1-21.

Example 26 comprises a method comprising any of the described operations of Examples 1-21.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a sensor configured to detect changes in an environment of a wireless communication device based on wireless communication signals communicated by the wireless communication device, the sensor comprising:
an input to receive signal information of a plurality of Receive (Rx) signals received by an Rx antenna of the wireless communication device based on a loopback of a plurality of wireless transmit (Tx) signals transmitted by a Tx antenna of the wireless communication device; and
a processor configured to determine a detection result based on a change in the signal information between an Rx signal and at least one previous Rx signal of the plurality of Rx signals, the detection result to indicate a detected change in the environment of the wireless communication device.

2. The apparatus of claim 1, wherein the processor is configured to monitor a detection metric, the detection metric based on the change in the signal information, and to determine the detection result based on the detection metric.

3. The apparatus of claim 2, wherein the processor is configured to determine training information of a plurality of training symbols of the Rx signal based on signal information corresponding to the Rx signal, to determine a value of the detection metric corresponding the Rx signal based on the training information of the plurality of training symbols of the Rx signal, and to determine the detection result based on the value of the detection metric corresponding the Rx signal.

4. The apparatus of claim 3, wherein the processor is configured to determine the value of the detection metric corresponding the Rx signal based on a correlation, in a time domain, between the training information of the plurality of training symbols of the Rx signal and reference training information.

5. The apparatus of claim 3, wherein the training information of the plurality of training symbols of the Rx signal comprises Long Training Field (LTF) information of a plurality of LTF symbols of the Rx signal.

6. The apparatus of claim 2, wherein the processor is configured to determine a time-domain Channel Impulse Response (CIR) corresponding to the Rx signal based on signal information corresponding to the Rx signal, and to determine a value of the detection metric corresponding the Rx signal based on the time-domain CIR corresponding to the Rx signal.

7. The apparatus of claim 6, wherein the processor is configured to determine the value of the detection metric corresponding the Rx signal based on a plurality of tap values of the time-domain CIR corresponding to the Rx signal.

8. The apparatus of claim 2, wherein the processor is configured to determine the detection result based on a comparison between a value of the detection metric corresponding the Rx signal and a detection threshold.

9. The apparatus of claim 8, wherein the processor is configured to update the detection threshold based a reliability criterion corresponding to a reliability of the detection result.

10. The apparatus of claim 1, wherein the processor is configured to select whether or not signal information corresponding to a particular Rx signal is to be used for determining the detection result based on a noise estimation corresponding to the signal information corresponding to the particular Rx signal.

11. The apparatus of claim 1, wherein the at least one previous Rx signal comprises an Rx signal immediately preceding the Rx signal.

12. The apparatus of claim 1 configured to cause the wireless communication device to transmit the Tx signals at a transmission power of no more than 50 decibel-milliwatts (dBm).

13. The apparatus of claim 1 configured to cause the wireless communication device to transmit the Tx signals at a transmission power of no more than 20 decibel-milliwatts (dBm).

14. The apparatus of claim 1 configured to cause the wireless communication device to transmit the Tx signals at a transmission periodicity of at least two signal transmissions per second.

15. The apparatus of claim 1, wherein the detection result comprises a proximity detection result to indicate a detected human proximity to the wireless communication device.

16. The apparatus of claim 1, wherein the detection result comprises user approach detection result to indicate a detected approach of a user to the wireless communication device.

17. The apparatus of claim 1, wherein the detection result comprises user move-away detection result to indicate a user moving away from the wireless communication device.

18. The apparatus of claim 1, wherein the detection result comprises a gesture detection result to indicate a detected gesture of a user of the wireless communication device.

19. The apparatus of claim 1 comprising a transmitter to transmit the plurality of wireless Tx signals, a receiver to receive the plurality of Rx signals, the Tx antenna, and the Rx antenna.

20. A product comprising one or more tangible computer-readable non-transitory storage media comprising computer-executable instructions operable to, when executed by at least one processor, enable the at least one processor to cause a sensor of a wireless communication device to detect changes in an environment of the wireless communication device based on wireless communication signals communicated by the wireless communication device, the instructions, when executed, cause the sensor to:
process signal information of a plurality of Receive (Rx) signals received by an Rx antenna of the wireless communication device based on a loopback of a plurality of wireless transmit (Tx) signals transmitted by a Tx antenna of the wireless communication device; and
determine a detection result based on a change in the signal information between an Rx signal and at least one previous Rx signal of the plurality of Rx signals, the detection result to indicate a detected change in the environment of the wireless communication device.

21. The product of claim 20, wherein the instructions, when executed, cause the sensor to monitor a detection metric, the detection metric based on the change in the signal information, and to determine the detection result based on the detection metric.

22. The product of claim 21, wherein the instructions, when executed, cause the sensor to determine training information of a plurality of training symbols of the Rx signal based on signal information corresponding to the Rx signal, to determine a value of the detection metric corresponding the Rx signal based on the training information of the plurality of training symbols of the Rx signal, and to determine the detection result based on the value of the detection metric corresponding the Rx signal.

23. The product of claim 21, wherein the instructions, when executed, cause the sensor to determine the detection result based on a comparison between a value of the detection metric corresponding the Rx signal and a detection threshold.

24. An apparatus for detecting changes in an environment of a wireless communication device based on wireless communication signals communicated by the wireless communication device, the apparatus comprising:
means for processing signal information of a plurality of Receive (Rx) signals received by an Rx antenna of the wireless communication device based on a loopback of a plurality of wireless transmit (Tx) signals transmitted by a Tx antenna of the wireless communication device; and
means for determining a detection result based on a change in the signal information between an Rx signal and at least one previous Rx signal of the plurality of Rx signals, the detection result to indicate a detected change in the environment of the wireless communication device.

25. The apparatus of claim 24 comprising means for monitoring a detection metric, the detection metric based on the change in the signal information, and determining the detection result based on the detection metric.
